(19) United States
(12) Patent Application Publication
(10) Pub. No.: US 2024/0370892 A1
(43) Pub. Date: Nov. 7, 2024

(54) SYSTEM AND METHOD FOR DETERMINING A MATERIALITY OF A TRANSACTION BREAK

(71) Applicant: THE BANK OF NEW YORK MELLON, New York, NY (US)

(72) Inventor: Narayan JHA, New York, NY (US)

(21) Appl. No.: 18/311,317

(22) Filed: May 3, 2023

(51) Int. Cl. G06Q 30/0201; G06Q 40/04

(52) U.S. Cl. CPC G06Q 30/0206; G06Q 40/04

(57) ABSTRACT

Provided are processes, systems, and methods for the investigation and resolution of transaction breaks such as, for example, reconciliation breaks. Breaks (e.g., discrepancies in records of transactions) often occur when there exists different systems or applications that operate in concert. A break refers to a situation where there is a discrepancy between details, attributes, or characteristics of a transaction across different computing systems or applications. In many cases, there exists a need to ensure consistency between the records of these different systems. Thus, for example, an entity may desire to resolve those breaks, such as to reduce risk, maintain compliance, or accurate accounting of records.

### CROSS-REFERENCE TO RELATED APPLICATIONS

No cross-reference is presented at this time.

### BACKGROUND

With the advent of computers, computer systems or applications that automate numerous transactions of assets have proliferated. In many cases, multiple such computer systems or applications may be authorized to perform transactions for assets within an account, or one or more computer systems or applications automating transactions of assets may report transactions to other computer systems or applications that act upon those transactions. For example, a customer may utilize an accounting or trading application to specify trades of assets that are held, or to be held, in custody by another party, like a bank, which may utilize a custody application to manage those assets. Inflows and outflows of assets between the accounting application and the custody application should match, but this is often not the case in practice, and these discrepancies are referred to as breaks.

### SUMMARY

Aspects of this disclosure relate to methods, apparatuses, and/or systems for determining a materiality of a break.

In some aspects, determining a materiality of a break comprises identifying a break associated with an asset based on detection of an exception quantity across one or more transactions of the asset, the exception quantity corresponding to an amount of difference in a net quantity value based on one or more positions of the one or more transactions of the asset; determining a market price and a trade price of the asset associated with the one or more transactions that make up the one or more positions for the asset; determining a contextualization value based on a materiality context associated with the one or more transactions for scoring the materiality of the break; determining, for each of the one or more transactions, a trade cost based on the trade price and position of the respective transaction; determining, for each of the one or more transactions, a market value based on the market price and position of the respective transaction; determining a net materiality difference based on an aggregate trade cost and an aggregate market value for the one or more transactions; and determining a materiality score indicative of the materiality of the break within the materiality context based on the net materiality difference and the contextualization value.

Various other aspects, features, and advantages of the disclosure will be apparent through the detailed description and the drawings attached hereto. It is also to be understood that both the foregoing general description and the following detailed description are exemplary and not restrictive of the scope of the disclosure.

### BRIEF DISCUSSION OF THE DRAWINGS

FIG. 1 illustrates a block diagram of a trade management system within which the present techniques may be implemented, in accordance with some embodiments;

FIG. 2 illustrates an example view of transaction records corresponding a materiality break, in accordance with some embodiments;

FIG. 3 illustrates a logic flowchart for determining a materiality of a transaction break, in accordance with some embodiments; and

FIG. 4 illustrates a block diagram depicting an example of a computing device by which the above techniques may be implemented.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION

To mitigate the problems described herein, the inventor had to both invent solutions and, in some cases just as importantly, recognize problems overlooked (or not yet foreseen) by others in the field of determining a materiality of a break. Indeed, the inventor wishes to emphasize the difficulty of recognizing those problems that are nascent and will become much more apparent in the future should trends in industry continue as the inventor expects. Further, because multiple problems are addressed, it should be understood that some embodiments are problem-specific, and not all embodiments address every problem with traditional systems described herein or provide every benefit described herein. That said, improvements that solve various permutations of these problems are described below.

Breaks (e.g., discrepancies in records of transactions) often occur when there exists different systems or applications that operate in concert. A break refers to a situation where there is a discrepancy between details, attributes, and/or characteristics of transactions across different computing systems or applications. In many cases, there exists a need to ensure consistency between the records of these different systems. Thus, for example, an entity often desires to resolve those breaks, such as to reduce risk, maintain compliance, or accurate accounting of records. Some examples of breaks may include, but are not limited to, transaction breaks, trade breaks, reconciliation breaks, dividend breaks, security position breaks, trade settlements breaks, Corporate Actions breaks for securities (e.g., having [X party] as custodian), mix of trade settlement breaks and Corporate Actions event breaks, Corporate Actions breaks for transactions resulting from litigation settlements, withholding tax breaks, Corporate Actions breaks for securities lending shares that have been loaned out and require dividends, etc., to be recovered from brokers who have the shares, failed trade breaks, Short-term Investment Fund (STIF) interest breaks, custody fee breaks, position Breaks, bank loan—Principal prepayment breaks, bank loan—Interest prepayment breaks, management fee Breaks, etc.

In some examples, certain entities (e.g., banks) perform financial reconciliations across various systems (e.g., risk and control) to maintain compliance, such as with respect to regulations, audits, or reviews. For many such entities, maintaining compliance involves implementing ongoing and proactive processes that are enforced internally (or externally, or both). Here, a break may correspond to a discrepancy between transactions of assets reported by different applications. For example, an accounting application may show a position for a security of 100 but a custody application may show a position for the same security of 50. The difference of 50 represents a break that needs to be investigated.

In other examples, a shipper, merchant, or manufacturer may utilize different computing systems or applications, like a customer facing application and an internal application, and the inflows and outflows of products, orders, or materials should match (or be maintained within threshold levels). Here, a break may similarly correspond to a discrepancy between transactions of assets reported by different applications. For example, a customer facing application may show that 100 widgets were purchased and shipped to the customer while an internal application may show that only 50 widgets were shipped. Accordingly, the difference of 50 represents a break that needs to be investigated.

Breaks can happen for a variety of reasons including, for example, transaction timing, messaging failures between systems, human errors, and the like. When a break occurs, an operations team typically investigates the root cause and generates correcting transactions (e.g., write offs) to clear breaks. Generally, this process is performed manually and in a piece-meal fashion, which is time and labor-intensive. In addition, there is a large variety of the types of breaks which might occur, each requiring a specific solution. These difficulties often compound potential concerns for entities that use systems prone to breaks, as those traditional systems fail to prioritize breaks in a meaningful way. Embodiments described herein mitigate these issues with improvements in detection and prioritization of breaks, such as by determining a materiality of a break (e.g., a transaction break) by which that break can be compared to other breaks and prioritized for resolution.

Those with skill in the art will appreciate that inventive concepts described herein may work with various system configurations. In addition, various embodiments of this disclosure may be made in hardware, firmware, software, or any suitable combination thereof. Aspects of this disclosure may also be implemented as instructions stored on a machine-readable medium, which may be read and executed by one or more processors. A machine-readable medium may include any mechanism for storing or transmitting information in a form readable by a machine (e.g., a computing device, or a signal transmission medium), and may include a machine-readable transmission medium or a machine-readable storage medium. For example, a machine-readable storage medium may include read only memory, random access memory, magnetic disk storage media, optical storage media, flash memory devices, and others. Further, firmware, software, routines, or instructions may be described herein in terms of specific exemplary embodiments that may perform certain actions. However, it will be apparent that such descriptions are merely for convenience and that such actions in fact result from computing devices, processors, controllers, or other devices executing the firmware, software, routines, or instructions.

In some example transactions, a customer or user buys or sells assets (e.g., securities) that are to be held or held by an entity, like a bank or other financial institution. The customer may utilize a customer facing accounting application to submit or otherwise view those transactions, which in some examples may be or linked to a trading platform. The account application may communicate via messages with an application of the bank or financial institution that has custody of the held securities or cash with which securities are purchased to be held by the bank. For example, the account application may communicate transactions to be effectuated to the custody application via one or more messages, and those transactions may be effectuated for the customer. Thus, the accounting application and custody application may each maintain respective records of transactions which, when reviewed, are expected to agree. As noted above, discrepancies in the respective records of transactions can occur, and these discrepancies should be resolved. Accordingly, accounting application records and custody application records may be obtained from the respective applications, or computing systems executing the respective applications.

A review process may be executed by one of the aforementioned computing systems, or another computing system, to identify transaction breaks based on comparisons between accounting application records and custody application records. In response to identifying a transaction break, a materiality determination may be performed, such as to score the transaction break. Transaction breaks may be ordered responsive to their respective scores for resolution prioritization.

Information about identified transaction breaks, like reconciliation breaks, may be reported as part of portfolio valuations to customers. In some examples, a materiality of a transaction break for a security may be assessed based on monetary value impact and basis point impact (BPI). Monetary value impact (MVI) may be determined based on an exception quantity (e.g., amount of discrepancy between the custody and accounting application records) for a transaction of a security and a market price of the security. The BPI, in turn, may be determined based on the MVI*10000 divided by a net asset value (NAV) of the portfolio. A BPI determination performed for a break in this manner only factors the exception quantity cost of a transaction break. This narrow assessment of materiality fails to provide an accurate assessment or indication of the true impact of the break on a portfolio in its entirety. For example, such a BPI determination tends to overreport issues because of its limited view of only looking at exception quantity and market price to quantify the impact of the materiality of the break for a security on a portfolio. Quantifying materiality of a break based only on quantity discrepancy for a transaction of a security can exaggerate the risk of the break because it does not account, for example, for actual trade and market price of transactions.

Rather than rely on a quantity-only based BPI determination for a transaction of a security, disclosed techniques for scoring breaks may determine a score based not just on an exception quantity for a security subject to a transaction break, but rather trade and market values in a Mark to Market BPI. Trade and market values in a Mark to Market BPI, in some example embodiments, may be determined at the level of an individual trade corresponding to transactions for a security. In some example embodiments, an individual trade cost-based Mark to Market BPI (ITCMMBPI) evaluation score of a break may be determined based on a net difference between trade cost and market value of transactions corresponding to a security for which a transaction break is detected, and NAV of a portfolio (times 10000, to convert to a BPI score value). As used herein, an ITCMMBPI may be referred to by other terminology, such as an ITC score, evaluation score, or score, and those scores need not be converted to BPI score values (e.g., multiplying by a factor of 10000) unless otherwise explicitly stated. Indeed, a BPI conversion may be used for reporting purposes to scale score values for improved readability by humans, but processes utilizing score values may operate on scaled or unscaled values. ITC scores are expected to provide a more accurate snapshot of overall impact of transaction breaks for a security on a portfolio, and those scores may be used to better prioritize transaction brakes for investigation and resolution.

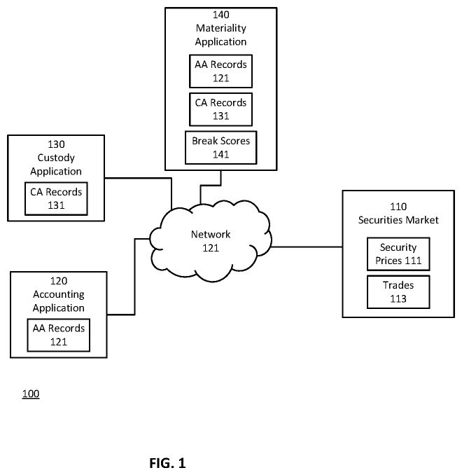

FIG. 1 illustrates a functional block diagram of an embodiment of trade management system 100 within which the present techniques may be implemented. The trade management system 100 is established to permit trading of assets (e.g., securities) on a market 110, like a securities market (or exchange) via network 121. Each of applications 120, 130, 140 may communicate with one or more of the other applications, securities market 110 or other entities via the network 121. In some examples, each of the applications may be executed on a respective computing system, though this need not always be the case. In some examples, one or more of the applications may be executed on a single computing system (which is not to suggest that such a computing system may not comprise multiple computing devices or nodes, or that each computing device or node need be co-located, indeed, a computing system comprising multiple servers that house multiple computing devices may be operated by a single entity and the multiple servers may be distributed, e.g., geographically). For example, in some embodiments, an entity like a bank may execute both a custody application 130 and a materiality application 140 on a computing system of the bank. Moreover, in some examples, the bank may also provide customers access to an accounting application 120, which may be a web-based application hosted by a computing system managed by or provisioned by the bank, or which communicates with such a computing system via an application programming interface. Accordingly, one or more of the depicted entities may communicate with one another via messages transmitted over a network 121, such as the Internet and/or various other local area networks. For example, one or more applications may communicate via messages transmitted over the network 121.

In some example embodiments, an accounting application 120 is a customer facing application with which a customer interfaces to manage their assets. While only one instance of an account application 120 is shown, embodiments of the environment 100 may include tens, hundreds, or thousands or more such applications accessed by different users on or from their respective computing systems. In some examples, such an application may also, or alternatively, be used internally, such as by an account or fund manager that specifies transactions for a customer or within a fund. The accounting application 120 and users of the accounting application may be isolated from accessing some or all of the information associated with the custody application 130. For example, an accounting application 120 may be a multi-tenant application to which multiple different customers or users have access and which only displays tenant-specific data to the respective tenant (e.g., customer or user). An interface, like an application programming interface (API) associated with a custody application 130, may facilitate the exchange of tenant-specific data (e.g., only the data which a user/user account of the accounting application 120 is permitted to view) between an account application 120 and custody application 130, like via messages transmitted over network 121. For example, a user of an account application 120 may access their customer account information or information about transactions and their properties specified by the user on the accounting application, and information about success/failure of processing a transaction by the custody application 130, but not information about how the custody application processed that transaction (e.g., via one or more trades 113 on the securities market 110, by assets held by the bank to minimize trade fees on the securities market, or combinations thereof consistent with the properties that were specified by the user).

In some example embodiments, an accounting application 120 may access information about securities, such as security prices 111, from the securities market 110 (or from a 3^{rd} party), to determine whether to effectuate one or more trades 113 of a security on the market 110, which in some examples may comprise transmitting properties for a transaction to be effectuated on the market. In other example use cases, the accounting application 120 may access information about shipping rates, quantities of assets (e.g., goods) available (e.g., in inventory), costs of assets (e.g., market), among other information by which a transaction for goods or services may be specified. The accounting application 120 may store accounting application (AA) records 121 indicative of properties of transactions specified by users of the accounting application to be effectuated. An example of such transactions and their associated properties may be for trades (e.g., buying, selling, etc.) 113 of securities on a securities market 110 based on security prices 111.

In some example embodiments, a custody application 130 is an internally facing application by which agents or employees of an entity manage assets of the entity. While only one instance of a custody application 130 is shown, embodiments of the environment 100 may permit multiple agents or employees of an entity implementing the custody application 130 to access respective instances of such an application from their respective computing systems. In some examples, a custody application 130 may provide information about assets held by the entity, and transactions corresponding to those assets. Some or all of those transactions may be effectuated by the entity based on properties of transactions specified by users of accounting application 120.

In some example embodiments, the custody application 130 may access information about securities, such as security prices 111, from the securities market 110 (or from a 3^{rd} party), to determine how to effectuate one or more trades 113 of a security available on the market 110 (or in some cases, already held and made available by the bank). Thus, in some examples, the custody application 130 may determine properties for one or more transactions to buy or sell (e.g., trade) securities (e.g., in accordance with policies or rules of the bank). Those properties determined by the custody application 130 may be based on properties for a transaction specified by users of accounting application 130, such as with respect to assets associated with a respective customer account with the entity. In practice, the custody application 130 may determine properties for one or more transactions that satisfy properties specified for a transaction (or even multiple transactions) by custody application 130. In other words, the custody application 130 may determine how to satisfy properties of transaction requested by users of custody application 120 based on market 110 security prices 111, assets held by the bank (and return on selling those assets based on the security prices 111, and other factors, and generate one or more transactions based on rules or policies of the bank determined to satisfy those transactions requested by users. The custody application 130 may obtain properties of transactions, such as for trades 113 of securities, requested by users from the accounting application 120, or a customer with access to the accounting application 120 (in which case the properties may be entered on the respective applications manually, e.g., by the customer on the accounting application 120 and/or by an agent of the bank on the custody application 130). In turn, the custody application 130 may store custody application (CA) records 121 indicative of transactions performed by the custody application to satisfy properties of transactions requested by accounting application 120.

In some example embodiments, a securities market 110 is a public market for buying and selling securities, such as via trades 113 of a security. The securities market 110 may be a platform which tracks trading of securities listed on the platform and market prices of those securities. Security prices 111 may be made public by the securities market 110 to facilitate trading in those securities, such as the buying or selling of a security based on the market price of that security. Applications, like an accounting application 120, custody application 130, or materiality application 140 may access security prices 111 in different ways. In some cases, prices 111 may be obtained by one or more of the applications from the securities market 110, such as from a computing system of the securities market via the network 121. In some cases, prices 111 may be obtained by one or more of the applications from a 3^{rd} party source, like a computing system that may aggregate security prices obtained from a number of different securities markets and provide those prices, such as via an API, to other applications or computing systems. In either case, computing systems executing applications like those depicted within the environment 100 may obtain market security pricing information, often in real or near real-time, corresponding to securities traded on the securities market 110.

An application, like the custody application 130, may obtain requests for transactions corresponding to trades on the securities market 110 and generate transactions for processing. For example, the custody application 130 may generate transactions based on requests for transactions received from an accounting application 120, which may store information about those requests in AA Records 121. The AA Records 121 may be indicative of a requested transaction, like an identifier of a security, whether to buy or sell the security, a price at which to buy or sell, and a quantity of the security. The custody application 130 may submit a transaction for a trade 113 for processing on the securities market 110, such as to buy or sell stock or other security traded on the market. The securities market 110 may match one or more transactions to buy a security with one or more transactions to sell a security, e.g., trades, and return confirmation of a trade corresponding to a transaction received from the custody application 130. The trade may then be settled, such as by the exchange of assets between a buyer and a seller, with an account managed by the custody application 130 being debited the trade cost in exchange for obtaining a corresponding amount of the security in the case of a buy or credited the trade cost in exchange for releasing a corresponding amount of the security in the case of a sell. The custody application 130, in turn, may store CA Records 131 indicative of the transaction, like an identifier of a security, whether it was a buy or sell, a trade price and market price of the security, and a quantity of the security exchanged. Additionally, a trade cost may be determined which, generally, may be the trade price times the quantity, although in some examples a trade cost may be adjusted to incorporate associated trade fees (which may be omitted for purposes of discussion herein without departing from the inventive aspects of the disclosed techniques).

In some example embodiments, a materiality application 140 obtains records from at least two different sources to identify transaction breaks and determine the materiality of those breaks. For example, the materiality application 140 may obtain CA Records 131 from a custody application 130 and AA Records 121 from an accounting application. In some examples, the custody application 130 and accounting application 120 may each generate reports comprising the respective records, such as for a given time period, like one or more minutes, hours, days, weeks, or months, which are then obtained by the materiality application 140. In some examples, the materiality application 140 may request records from one or more of the custody application 130 and/or accounting application 120 corresponding to a given time period. In either case, the materiality application 140 may obtain a set of AA Records 121 and set of CA records 131, e.g., a first set of records and a second set of records for comparison, such as for a given time period.

The materiality application 140, in some examples, may compare obtained sets of records to identify a break corresponding to one or more transactions. For example, the materiality application 140 may compare a first set of records, like AA Records 121, to a second set of records, like CA Records 131, which, when reviewed by the materiality application 140, are expected to agree. However, as noted above, discrepancies in the respective records of transactions can occur. The materiality application 140 may identify discrepancies between the first and second set of records based on transactions indicated in the records. In some examples, the materiality application 140 may conditionally format one or more fields of values in a first set of records, and in some cases may apply an inverse of the conditional format to respective fields of values in a second set of records, such as for determining a net discrepancy among a set of records.

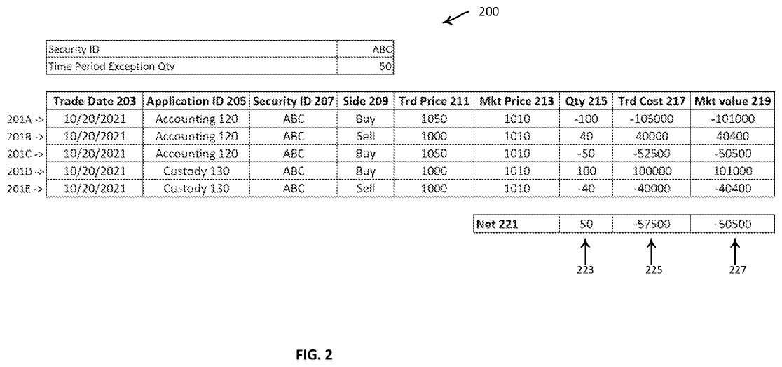

FIG. 2 illustrates an example view 200 of transaction records corresponding to a materiality break. The transaction records may include information about transactions obtained from two different sources, such as an accounting application 120 and a custody application 130. Some of the information associated with example transactions shown may be determined based on information contained in records obtained from a records source, or in some examples from information obtained from other sources based on information contained in records obtained from the records sources. In other words, records obtained from a source need not include each informational component depicted, some of the shown information may be determined with respect to a transaction based on record information and information obtained from other sources (e.g., like market and trade pricing data obtained for a security identified by a transaction). Embodiments of transaction records may include all or some of the example information depicted, and in some examples, may contain other or additional information, e.g., like a time stamp down to the minute or second or fraction of a second on the day which a transaction occurred, a fund or account identifier, or other information pertinent to a use case.

As shown, the example view 200 corresponds to transactions for a given security 207, i.e., “ABC”, for a given time period, such as over a given day, for which there may be an exception quantity corresponding to a transaction break. Example transaction records 201, as shown, may include information like a trade date 203, like a timestamp, by which the materiality application 140 may determine whether a transaction falls within a given time period being examined for a transaction break for a given security (i.e., “ABC”) based on a security ID 207. Transaction records 201 may include an application identifier 205 field, such as to identify which set of records a transaction corresponds. In the illustrated example, transactions 201A-C may correspond to transactions reported in AA Records 121 obtained from an accounting application 120 and transactions 201D-E may correspond to transactions reported in CA Records 131 obtained from a custody application 130, such as indicated by their respective values for Application ID 205. Example transaction records 201 may also indicate a side 209 for a transaction, such as whether a transaction corresponded to a “buy” or “sell” of a security. While text values for the different sides 209 are shown for ease of explanation, other values may be used to indicate a side, for example, “0” or another value may correspond to a buy and “1” or another value may correspond to a sell. Additionally, embodiments may use additional values to indicate other or different sides, depending on use case. Other values may also be associated with transaction records, such as a trade price 221, market price 213, quantity 215, trade cost 217, and market value 219 corresponding to the transaction. Additionally, net values 221 may be determined (e.g., by a materiality application) for one or more fields based on field values of transaction records selected for analysis.

In some embodiments, the materiality application 140 may determine net 221 values associated with one or more fields across the first and second sets of records. Prior to determining a net value 221 for a given field, the materiality application 140 may conditionally format values within the given field, such as based on one or more values in other fields of a transaction record. The materiality application 140, in some examples, may determine net values 221 based on a difference between the first and second sets of records. Accordingly, for a given transaction side, e.g., “buy”, values in a first set of transactions for buy side may be conditionally formatted to have an opposing sign (i.e., negative or positive) from values for the given transaction side in a second set of transactions such that a sum of those values by which a net value is determined is indicative of a difference (e.g., for the buy side). Conditional formatting may be applied for one or more different sides based on, for example, whether a transaction corresponds to a first set of records or a second set of records. Each transaction 201 may be associated with an identifier indicative of which record set the transaction corresponds by which a materiality application may apply conditional formatting to values in one or more fields.

For example, as shown, “Buy” side 209 transactions (i.e., 201A, 201C) having an application ID 205 corresponding to an accounting application 120 record set may have values in one or more fields conditionally formatted by the materiality application 140, such as the Quantity 215, Trade Cost 217, and Market Value 219 to be signed as negative values.

Conversely, as shown, “Buy” side 209 transactions (i.e., 201D) having an application ID 205 corresponding to a custody application 130 record set may have their values in corresponding fields conditionally formatted by the materiality application 140 to be signed oppositely, i.e., as positive values in the example, from same side transactions in the other record set.

In turn, “Sell” side 209 transactions (i.e., 201B) with application IDs 205 corresponding to the accounting application 120 record set may have their values in corresponding fields conditionally formatted to be signed oppositely, i.e., as positive values in the example, from “Buy” side transactions in the same record set.

Similarly, “Sell” side 209 transactions (i.e., 201E) with application IDs 205 corresponding to the custody application 120 record set may have their values in corresponding fields conditionally formatted to be signed oppositely, i.e., as negative values in the example, from either “Buy” side transactions in the same record set or “Sell” side transaction in the other record set.

In one example, the materiality application 140 may apply conditional formatting in a Qty field for transactions as follows:
if Application ID=“Accounting” and Side=“Buy”, set Qty=“abs(Qty)*(−1)”;
else if Application ID=“Accounting” and Side=“Sell”, set Qty=“abs(Qty)”;
else if Application ID=“Custody” and Side=“Sell”, set Qty=“abs(Qty)*(−1)”;
else if Application ID=“Custody” and Side=“Buy”, set Qty=“abs(Qty)”;
   Other fields of the transaction (and other transactions) may similarly be conditionally formatted by the materiality application 140 in accordance with the principles described above such that a net value determined across a first set of transaction records and a second set of transaction records is indicative of a net discrepancy in their reported values.

As shown in FIG. 2, net values 221 indicative of exception values, like a quantity discrepancy 223, trade cost discrepancy 225, and market value discrepancy 219 may be determined based on a sum of the respective quantity 215, trade cost 217, and market value 219 field values across the transactions 201A-E. In accordance with the illustrated example, a quantity discrepancy 223 of 50 (which may be reported as an absolute value in some examples, such as depicted in FIG. 2), trade cost discrepancy 225 of −57500, and market value discrepancy 227 of −50500 may be determined based on a sum of the values in the respective field across the example transactions 201A-E.

Turning back to FIG. 1, embodiments of a materiality application 140 may determine break scores 141 based on an analysis of a first set of records and a second set of records, such as the AA Records 121 and the CA Records 131. An analysis of the record sets may, for example, identify an exception quantity (e.g., a net difference in quantity) across transactions for a security within the record sets. For example, based on the transactions described with reference to FIG. 2, the materiality application 140 may determine an exception quantity of 50 (e.g., at element 223 based on a sum of quantity values across the records, which may be conditionally formatted quantity values) because inflows and outflows reported for transactions by the different records do not cancel out, thereby identifying a transaction break. In response to identifying a transaction break, the materiality application 140 may score the break, such as by determining a break score 141. The materiality application 140 may analyze transactions for a given time period for a plurality of different securities to identify a set of transaction breaks. In turn, the materiality application 140 may score one or more breaks identified to the set of transaction breaks, such as to determine respective break scores 141 for the given time period. In some examples, the materiality application 140 may obtain AA Records 121 and CA Records 131 after an elapsed time period, such as over the last 24 hours, or for a last period over which a securities market 110 was available for trading 113, identify one or more transaction breaks for that time period, and determine break scores 141 for the identified transaction breaks.

In some embodiments, after determining an exception quantity indicative of a transaction break corresponding to a security, the materiality application 140 may determine a market price of the security. For example, the materiality application 140 may obtain a market price of the security with an API call to an internal or external source to obtain security pricing 111 of one or more securities on the securities market 110. Additionally, the materiality application 140 may obtain a trade price of the security, such as based on reported trades 113 corresponding to the security on the securities market 110. In some examples, the materiality application 140 may determine the market price and trade price for each transaction corresponding to the security that occurred during the time period being analyzed. In some examples, market price and trade price corresponding to a transaction may be based on or obtained from information reported in the records of transactions (e.g., AA or CA Records). For example, in some embodiments, AA or CA Records may contain market and pricing information by which the market price and trade price corresponding to the transaction for the security may be determined. In some embodiments, the materiality application 140 may determine (or infer) one or more of the market and trade price based on information about security prices 111, such as over the time period, and a time stamp corresponding to a transaction reported within that time period. Thus, for example, in some embodiments, the materiality application 140 may determine one or more values for fields corresponding to transactions, such as example transactions described with reference to FIG. 2.

In some embodiments, after obtaining trade price and market price information corresponding to one or more transactions identified to a set of transactions of a security for which a transaction break is detected, the materiality application 140 may determine trade cost and market value corresponding to each transaction, such as based on the trade price and market price obtained or determined for the transaction. The materiality application 140 may conditionally format one or more of the trade cost and market values corresponding to a transaction based on information associated with the transaction, such as prior to determining a net value for the respective field. In some examples, the trade cost and market value may be formatted to carry the sign associated with a quantity value that has already been conditionally formatted for the transaction, such as by multiplication of a (conditionally formatted positive or negative signed) quantity value and (positive) trade price to determine (a signed, positive or negative) trade cost, and multiplication of the (conditionally formatted positive or negative signed) quantity value and (positive) market price to determine (a signed, positive or negative) market value. As shown in FIG. 2, the trade cost 217 and market value 219 field value signs of a transaction may follow the sign conditionally set for the quantity value of a transaction. Accordingly, the net trade cost 225 and net market value 227 should be zero (or approximately zero) in instances where the net quantity is not indicative of a transaction break. However, where a transaction break is identified, such as in the illustrated example of FIG. 2, the net value 225 for trade cost 217 and net value 227 for market value 219 may similarly indicate corresponding exception values (e.g., −57500 and −50500, respectively, shown in FIG. 2 as absolute values).

The materiality application 140 may determine an overall net difference value based on the trade cost net 225 and market value net 227, such as by subtracting one value from the other. The overall net difference value may be reported as an absolute value of the difference, in which case whether the trade cost net 225 is subtracted from the market value net 227 or vise versa does not affect output. In some examples, however, the overall net difference value may be signed, such as to indicate directionality of a transaction break rather than just its magnitude. For example, a signed net difference value may indicate whether a break is buy side or sell side with respect to a given record set.

In some embodiments, the materiality application 140 may determine a score 141 for a transaction break based on the net difference value and a NAV corresponding to a fund or account to which the transactions correspond. The materiality application 140 may determine a NAV of a fund or account based amounts of securities and security prices 111 and amounts and prices of other assets held by the fund or account. In turn, the materiality application 140 may score a transaction based by dividing the net difference value by the NAV. For example, in accordance with the example of FIG. 2, the materiality application 140 may determine a net difference value of 7000 (based on the absolute value of (−57500)−(−50500)), which may be divided by a determined NAV of the corresponding fund or account to which the transaction break corresponds. For a determined NAV of 100,000,000 (e.g., dollars), the net difference value (7000) divided by the NAV may thus correspond to a determined break score of 0.00007, which in some examples may be scaled to a BPI break score (e.g., of 0.7) by multiplying the break score by 10,000. In either case, the break score may be stored by the materiality application 140 to a set of break scores 141 determined for a given time period. A break score record stored to the set of break scores 141 may include information such as the security or asset corresponding to the transaction break, fund or account information, and the associated break score, among other information (e.g., like the time period over which the transaction break occurred). Break scores 141 determined in accordance with the above techniques accurately reflect exposure from an individual trade of a security for a fund or account to reconcile the break. As trade cost and market value can fluctuate over the duration of a period examined for a transaction break and thus among those transactions within the period, a net difference between respective sums between trade cost and market value is indicative of a materiality value that, when divided by the NAV of a fund or account, accurately reflects materiality of the exposure within the context of the fund or account.

As described above, the materiality application 140 may determine a score for one or more breaks occurring during a given time period for which a first set and a second set of records are analyzed. Thus, the materiality application 140 may determine a score for each of a plurality of breaks. Each break score, as described above, may be determined based on an overall net difference between a net trade cost and net market value of transactions reported for a security for which a transaction break is detected, where the overall net is then divided by a NAV for an account or fund to which the transactions correspond. Accordingly, the determined break score takes into account a raw materiality of the exposure resulting from the break, i.e., the overall net difference, relative to the overall value of the fund or account. Thus, when multiple breaks are identified in relation to a fund or account, an ordering (e.g., of highest to lowest) of the break scores determined for the account is indicative of which break corresponds to the highest prioritization (e.g., of investigation and resolution of the break). Other orderings and/or rankings may also be generated, such as across different accounts to generate an ordered and/or ranked listing (e.g., by score) of transaction breaks that have a higher to lower materiality (or vice versa) on their respective funds or accounts. Some examples may implement a fund or account segmented approach, such as to generate a ranked listing by score of transaction breaks for funds or accounts within a given NAV range, e.g., 100-200 m, 200-300 m, etc., such that transaction breaks may be ranked by score among funds or accounts with similar NAVs. In some embodiments, breaks may be displayed, e.g., on a display, in an order that corresponds to the respective materiality scores of the breaks.

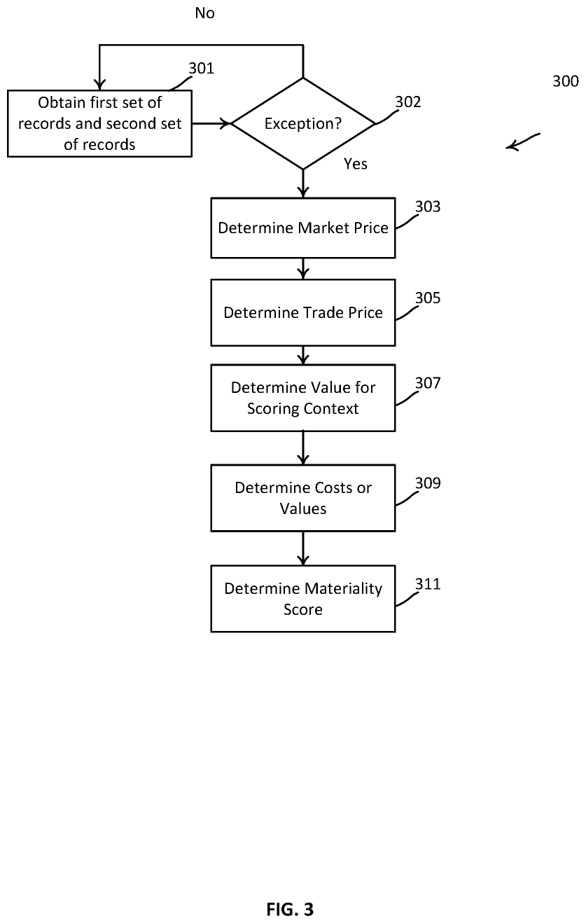

FIG. 3 depicts a flowchart illustrating an embodiment of a method or process 300 for determining a materiality of a transaction break, which may be configured to optimize or otherwise enhance or make more efficient scoring and prioritization of transaction breaks for analysis or reconciliation. In some embodiments, process 300 may be implemented by one or more algorithms which may be configured to be executed on a computing device, such as a computing device executing a materiality application within the context of an environment 100 like that described with reference to FIG. 1. A score or scores determined by embodiments of the process 300 may be based on trade and market values corresponding to transactions in a Mark to Market BPI rather than (e.g., solely) on an exception quantity. Indeed, embodiments may determine whether an exception quantity exists for a security to identify a transaction break but may make determinations based on other or additional factors to determine a score indicative of a materiality of the transaction break that accurately reflects exposure resulting from the break relative to more naïve processes.

Embodiments of process 300 may determine a materiality score corresponding to a break in accordance with techniques described herein for determining an individual trade cost mark to market score (e.g., an ITC score). For example, embodiments of process 300 may determine an ITC score based on a net difference between trade cost and market value of transactions corresponding to a security for which a transaction break is detected, and NAV of a portfolio. Some embodiments of the process 300 may determine an ITCMMBPI evaluation score by scaling the ITC score (e.g., by a factor of 10000, to convert to a BPI score value). In either case, scoring of a materiality of a transaction break in accordance with the present techniques is expected to provide a more accurate snapshot of overall impact of transaction breaks for a security on a portfolio, and those scores may be used in accordance with some embodiments of the disclosed process 300 to prioritize transaction brakes for investigation and resolution. Some embodiments of the example process 300 may include additional or other steps, and some steps may be combined or omitted, such as depending on the use case.

In a step 301, embodiments of a process 300 for determining a materiality of a break may obtain one or more sets of records comprising transactions. For example, a computing device may obtain a first set of records and a second set of records, such as from different applications, such as first application distinct from a second application. The different applications need not execute on different computing devices to constitute being different or distinct applications, rather, the terminology is intended to emphasize that the different applications generate respective sets of records that are distinctly attributable to the respective application. In some embodiments, a computing device executing the process 300 may execute one or more of the other applications, which is not to suggest that the computing device executing the process cannot be distinct from computing devices (or device) executing those applications. In some example embodiments, a first set of records may comprise records of transactions stored by a first application, such as an accounting application, and a second set of records may comprise records of transactions scored by a second application, such as a custody application.

In a step 302, the first records and second records may be analyzed to determine whether there exists an exception condition between the first records and second records. For example, embodiments may determine whether transaction information included in the records indicates an exception quantity, where an exception quantity reflects an identified difference in relevant values contained in transaction information for a position across one or more transactions identified based on the records and corresponding to the position. For example, an exception quantity may correspond an identified difference based on inflow and outflow quantities (e.g., transaction information) reported for transactions described by the records.

As described above, a first set of records may be distinctly attributable to a first application or records source, and a second set of records may be distinctly attributed to a second application or records source. In some embodiments, a first set and a second set of transactions may be selected from respective record sets, such as based on transaction information. For example, respective subsets of transactions occurring over a given period of time for analysis may be selected from the records where the records include transactions occurring over a greater period of time. In another example, respective subsets of transactions corresponding to a given asset, like a given security, may be selected from the records where the records include transactions corresponding to multiple assets. In another example, respective subsets of transactions corresponding to a given account or fund may be selected from the records where the records include transactions corresponding to multiple funds or accounts. Embodiments of the process may select respective subsets based on applying one or more of the above criteria to a respective record set as applicable. Thus, for example, a first subset of transactions may be selected (or obtained) from the first set of records and a second subset of transactions may be selected (or obtained) from the second set of records for analysis to determine whether an exception is detected among the selected transactions based on their transaction information. If an exception is not detected, the process 300 may obtain next respective subsets of transactions from the record sets based on modified criteria, such for a next or another asset (like a next or another security identifier indicated in transaction information for at least one transaction in at least one record set), or a different time period, or a different account or fund, to determine whether an exception exists among transactions meeting the modified criteria. In some aspects, the process may iterate over a plurality of pairings of records sets or transaction selection criteria within a given pairing until detecting an exception.

In some embodiments, an exception, such as an exception quantity may be detected or identified based on a comparison of inflow quantity values reported for transactions within the first record set to inflow quantity values reported for transactions within the second record set, and a likewise comparison for outflow quantity values. Embodiments of the process 300, such as in step 302, may conditionally format one or more relevant values of one or more fields of transaction information based on a record source or application identifier for a transaction (e.g., whether the transaction corresponds to a first application or second application) and based on whether the transaction corresponds to an inflow or outflow. For example, with respect to determining an exception quantity in transactions indicative of buying (inflow) or selling (outflow) of an asset, like a security, embodiments may conditionally format reported quantities of a security for one or more first transactions indicative of buys in a first record set oppositely (e.g., negative values) from reported quantities of the security for one or more second transactions indicative of buys in the second record set (e.g., positive values). Similarly, embodiments may conditionally format reported quantities of the security for one or more first transactions indicative of sells in the first record set oppositely (e.g., positive values) from reported quantities of the security for one or more second transactions indicative of sells in the second record set (e.g., negative values). Additionally, as can be seen, the reported quantities for buys and sells within a respective record set may be conditionally formatted to be oppositely signed.

Accordingly, in cases where inflows and outflows are consistent among transactions reported for the security by the first record set and the second record set, a net quantity value determined across the transactions based on a sum of the conditionally formatted quantities will have a zero net quantity value. Where no exception quantity is detected, the process 300 may return to step 301, such as to continue processing the obtained records sets, or subsequently obtained record sets, until an exception is detected as described with reference to step 302.

Conversely, in cases where inflows and outflows are not consistent among transactions reported for the security by the first record set and the second record set, a net quantity value determined across the transactions based on a sum of the conditionally formatted quantities will have a non-zero net quantity value. An example exception, like an exception quantity, may be determined when a net quantity value based on the sum of the conditionally formatted quantities is non-zero, that result being indicative of a transaction break between transactions from the first record set and transactions from the second record set. Thus, for example, embodiments of step 302 may determine an exception quantity corresponding to a detected difference in a net quantity value based on one or more positions of one or more transactions, that detected difference being indicative of a break associated with the one or more transactions. In response to detecting an exception indicative of a break associated with one or more transactions, the process may proceed to step 303.

In step 303, the process may determine a market price corresponding to an asset for which a transaction break is detected. For example, a market price of an asset associated with the one or more transactions that make up the one or more positions for the asset corresponding to the break may be determined. In some examples, a market price of a security may be determined, such as with an API call to an internal or external source to obtain security pricing. In some examples, a market price of the asset may be determined with respect to each transaction, such as based on transaction information or market pricing corresponding to a reported timestamps for the transaction. In other examples, a current market price of the asset may be determined for application to each transaction.

In step 305, the process may determine a trade price corresponding to an asset for which a transaction break is detected. For example, a trade price of an asset associated with the one or more transactions that make up the one or more positions for the asset corresponding to the break may be determined. In some examples, a trade price of a security may be determined, such as with an API call to an internal or external source to obtain information about effectuated trades of the security. In some examples, a trade price of the asset may be determined with respect to each transaction, such as based on transaction information or trade pricing corresponding to a reported timestamps for the transaction. In other examples, a current trade price of the asset may be determined for application to each transaction.

In step 307, the process may determine an overall value (or amount) associated with the asset for a score context. Depending on use case, an overall value may correspond to a (e.g., reported) net amount of the asset, a net value of the asset, or a net value of an asset pool, account or fund including the asset. The overall value may be a metric by which a materiality score for a transaction break identified for the asset is to be contextualized, such as a net asset value (NAV) of a portfolio to which the asset belongs. For example, for a security, embodiments of step 307 may determine a NAV corresponding to an account or fund (e.g., a given portfolio including the asset) associated with one or more transactions involving a security for which a transaction break is detected (e.g., an exception in step 302). In some examples, determining a NAV corresponding to an account or fund may comprise obtaining account or fund information, such as a net asset balance at the end of a period for which an exception is detected. In some embodiments, determine a NAV based on marketing pricing obtained for assets held by a fund or the accounts. In some embodiments, a NAV may be determined for assets held by an entity, such as by a bank or other entity, rather than or in addition to on an account or fund level. Thus, for example, materiality of a break may be contextualized in different ways, and materiality scores may differ for different contexts. Embodiments may select one or more contexts by which to contextualize a materiality of the break corresponding to the one or more transactions, such as by determining an overall value for each selected context. Some examples may score a materiality of a break corresponding to transactions of a security, for example, with respect to one or more of a fund, account, or entity by determining a net asset value with respect to a given context.

In step 309, the process may determine one or more costs or values associated with transactions corresponding to the break for the asset. For example, for a security, embodiments may determine a trade cost and a market value for each transaction that makes up a position difference for a specific portfolio-asset combination. In some embodiments, the process may determine the trade cost and the market cost for each of the one or more transactions associated with the identified break. As described above, transactions may be obtained from either a first set of records or a second set of records. Accordingly, a set first set of transactions obtained from the first set of records and a second set of transactions obtained from the second set of reach may each be evaluated to determine a trade cost and a market value for each transaction, such as based on a quantity of security associated with the transaction, like a change in position of the security corresponding to the transaction, and determined trade cost (e.g., step 350) or market price (e.g., in step 303), respectively. Transaction information for the one or more transactions corresponding to the break may be updated based on the determined costs and values, such as by specifying for each transaction a value for a respective field or data category, like one or more of a trade cost or market value fields or data categories of a record of a transaction.

Embodiments of the process may conditionally format a value within one or more of the aforementioned fields or data categories, such as either negative or positive, based on whether a transaction corresponds to the first record set or the second record set and whether the transaction corresponds to a buying or selling of the security (e.g., whether an amount of change in position corresponds to an increase or decrease). In some examples, whether a value within a field is positive or negative may be determined based on previously conditionally formatted value, like an amount of position change associated with the transaction (e.g., a signed quantity value determined in associated with step 302), and an unsigned (e.g., positive value) from another field.

In a step 331, the process may determine a materiality score for a transaction break. In some embodiments of the process may determine a difference between respective net values determined across the one or more transactions corresponding to the break for the asset. For example, a first net value may be determined based on first data values in a first field or data category for the one or more transactions and a second value may be determined based on second data values in a second field or data category for the one or more transactions. In some example embodiments, such as for a security, the first net value may be based on a sum of trade cost determined for each of the transactions and the second net value may be based on a sum of market value determined for each of the transactions. Thus, for example, the process may determine a net trade cost and a net market value based on the respective fields or data categories of the one or more transactions associated with the break. In turn, embodiments of the process may determine a difference (e.g., a net difference) between the net trade cost and the net market value, the difference corresponding to an evaluation of materiality of a break in some examples, such as those involving a security. A materiality score, in turn, may be determined based on the net difference and the value determined for scoring context in step 307. For example, a materiality score for an asset, like a security, may be determined by dividing the net difference by a NAV determined in step 307. In some examples, the net difference may be reported as an absolute value of the difference between the net trade cost and the net market values. In some examples, a materiality score may be scaled, such by a factor of 10000 to convert a materiality score into a BPI-based score.

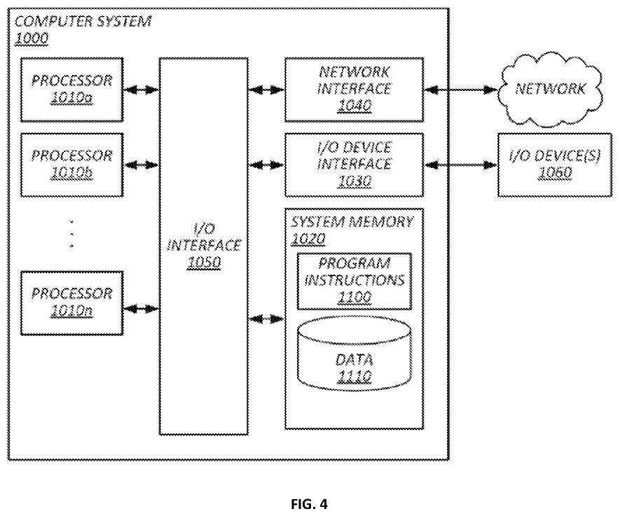

Some embodiments may execute the above operations on a computer system, such as the computer system of FIG. 4, which is a diagram that illustrates a computing system 1000 in accordance with embodiments of the present techniques. Various portions of systems and methods described herein, may include or be executed on one or more computer systems similar to computing system 1000. Further, processes and modules described herein may be executed by one or more processing systems similar to that of computing system 1000.

Computing system 1000 may include one or more processors (e.g., processors 1010a-1010n) coupled to system memory 1020, an input/output I/O device interface 1030, and a network interface 1040 via an input/output (I/O) interface 1050. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1000. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1020). Computing system 1000 may be a uni-processor system including one processor (e.g., processor 1010a), or a multi-processor system including any number of suitable processors (e.g., 1010a-1010n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 1000 may include a plurality of computing devices (e.g., distributed computer systems) to implement various processing functions.

In some embodiments, I/O device interface 1030 may provide an interface for connection of one or more I/O devices 1060 to computer system 1000. I/O devices may include devices that receive input (e.g., from a user) or output information (e.g., to a user). I/O devices 1060 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface 1040 may facilitate data exchange between computer system 1000 and other devices connected to the network. Network interface 1040 may support wired or wireless communication. The network may include an electronic communication network, such as the Internet, a local area network (LAN), a wide area network (WAN), a cellular communications network, or the like.

System memory 1020 may be configured to store program instructions 1100 or data 1110. Program instructions 1100 may be executable by a processor (e.g., one or more of processors 1010a-1010n) to implement one or more embodiments of the present techniques. Instructions 1100 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier having program instructions stored thereon. A tangible program carrier may include a non-transitory computer readable storage medium. A non-transitory computer readable storage medium may include a machine-readable storage device, a machine-readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium that may have program instructions stored thereon that are executable by a computer processor (e.g., one or more of processors 1010a-1010n) to cause the subject matter and the functional operations described herein. A memory (e.g., system memory 1020) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times.

I/O interface 1050 may be configured to coordinate I/O traffic between processors 1010a-1010n, system memory 1020, network interface 1040, I/O devices 1060, and/or other peripheral devices. I/O interface 1050 may perform protocol, timing, or other data transformations to convert data signals from one component (e.g., system memory 1020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000 or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices or software that may perform or otherwise provide for the performance of the techniques described herein. For example, computer system 1000 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, third party content delivery networks may host some or all of the information conveyed over networks, in which case, to the extent information (e.g., content) is said to be supplied or otherwise provided, the information may provided by sending instructions to retrieve that information from a content delivery network.

The reader should appreciate that the present application describes several independently useful techniques. Rather than separating those techniques into multiple isolated patent applications, applicants have grouped these techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to costs constraints, some techniques disclosed herein may not be presently claimed and may be claimed in later filings, such as continuation applications or by amending the present claims. Similarly, due to space constraints, neither the Abstract nor the Summary sections of the present document should be taken as containing a comprehensive listing of all such techniques or all aspects of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a clement” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Similarly, reference to “a computer system” performing step A and “the computer system” performing step B can include the same computing device within the computer system performing both steps or different computing devices within the computer system performing steps A and B. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X'ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Features described with reference to geometric constructs, like “parallel,” “perpendicular/orthogonal,” “square”, “cylindrical,” and the like, should be construed as encompassing items that substantially embody the properties of the geometric construct, e.g., reference to “parallel” surfaces encompasses substantially parallel surfaces. The permitted range of deviation from Platonic ideals of these geometric constructs is to be determined with reference to ranges in the specification, and where such ranges are not stated, with reference to industry norms in the field of use, and where such ranges are not defined, with reference to industry norms in the field of manufacturing of the designated feature, and where such ranges are not defined, features substantially embodying a geometric construct should be construed to include those features within 15% of the defining attributes of that geometric construct. The terms “first”, “second”, “third,” “given” and so on, if used in the claims, are used to distinguish or otherwise identify, and not to show a sequential or numerical limitation. As is the case in ordinary usage in the field, data structures and formats described with reference to uses salient to a human need not be presented in a human-intelligible format to constitute the described data structure or format, e.g., text need not be rendered or even encoded in Unicode or ASCII to constitute text; images, maps, and data-visualizations need not be displayed or decoded to constitute images, maps, and data-visualizations, respectively; speech, music, and other audio need not be emitted through a speaker or decoded to constitute speech, music, or other audio, respectively. Computer implemented instructions, commands, and the like are not limited to executable code and can be implemented in the form of data that causes functionality to be invoked, e.g., in the form of arguments of a function or API call. To the extent bespoke noun phrases are used in the claims and lack a self-evident construction, the definition of such phrases may be recited in the claim itself, in which case, the use of such bespoke noun phrases should not be taken as invitation to impart additional limitations by looking to the specification or extrinsic evidence.

In this patent, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

1. A method for determining a materiality of a break, comprising:
identifying a break associated with an asset based on detection of an exception quantity across one or more transactions of the asset, the exception quantity corresponding to an amount of difference in a net quantity value based on one or more positions of the one or more transactions of the asset;
determining a market price and a trade price of the asset associated with the one or more transactions that make up the one or more positions for the asset;
determining a contextualization value based on a materiality context associated with the one or more transactions for scoring the materiality of the break;
determining, for each of the one or more transactions, a trade cost based on the trade price and position of the respective transaction;
determining, for each of the one or more transactions, a market value based on the market price and position of the respective transaction;
determining a net materiality difference based on an aggregate trade cost and an aggregate market value for the one or more transactions; and
determining a materiality score indicative of the materiality of the break within the materiality context based on the net materiality difference and the contextualization value;
identifying a plurality of breaks within the materiality context;
determining, for each of the plurality of breaks, a respective materiality score; and
displaying, on a display, the plurality of breaks in an order that corresponds to the respective materiality scores of each of the plurality of breaks.

2. The method of claim 1, wherein a first subset of the transactions is obtained from a first record source and a second subset of the transactions is obtained from a second record source.

3. The method of claim 2, wherein the first record source is distinct from the second record source.

4. The method of claim 2, wherein:
the first subset of the transactions is obtained from a first application;
the second subset of the transactions is obtained from a second application; and
the first application is distinct from the second application.

5. The method of claim 2, further comprising:
conditionally formatting a quantity value of a position based on a record source of a corresponding transaction and whether the position corresponds to an increase or decrease in amount of the asset.

6. The method of claim 5, wherein:
quantity values of positions of the first subset of the transactions are formatted oppositely of quantity values of positions of the second subset of the transactions; and
within respective subsets, quantity values of positions corresponding to an increase in amount of the asset are formatted oppositely of quantity values of positions corresponding to a decrease in amount of the asset.

7. The method of claim 1, wherein a trade price and a market price of the asset associated with the break is determined for each transaction.

8. The method of claim 1, wherein:
the contextualization value is a net asset value (NAV) of a portfolio with which the one or more transactions of the asset are associated.

9. The method of claim 8, further comprising:
determining the NAV of the portfolio based on quantities and market prices of a plurality of assets;
determining a basis point impact (BPI) materiality score for the portfolio by scaling the materiality score.

10. The method of claim 1, wherein the materiality score for the break is determined as an unsigned value of the net materiality difference, the net materiality difference being based on conditionally formatted trade cost amounts and conditionally formatted market value amounts.

11. The method of claim 10, wherein:
at least some of the trade cost or market value amounts are negative; and
at least some other of the trade cost or market value amounts are positive.

12. The method of claim 1, wherein the amount of difference in the net quantity value is a difference in a number of shares of the positions being reconciled for the asset.

13. (canceled)

14. The method of claim 1, further comprising:
selecting the one or more transactions from records of transactions obtained from two distinct sources based on transaction selection criteria.

15. The method of claim 14, wherein the transactions selection criteria comprises one or more of:
a time period for detecting a break; and
an asset identifier of the asset among other assets represented in the records of transactions.

16. The method of claim 1, wherein the asset is a security.

17. The method of claim 1, wherein the break is one of:
a trade break,
a reconciliation break,
a dividend break, or
a security position break.

18. A system for determining a materiality of a break, comprising:
a computer having a processor and a memory; and
one or more code sets stored in the memory and executed by the processor, which, when executed, configure the processor to:
identify a break associated with an asset based on detection of an exception quantity across one or more transactions of the asset, the exception quantity corresponding to an amount of difference in a net quantity value based on one or more positions of the one or more transactions of the asset;
determine a market price and a trade price of the asset associated with the one or more transactions that make up the one or more positions for the asset;
determine a contextualization value based on a materiality context associated with the one or more transactions for scoring the materiality of the break;
determine, for each of the one or more transactions, a trade cost based on the trade price and position of the respective transaction;
determine, for each of the one or more transactions, a market value based on the market price and position of the respective transaction;
determine a net materiality difference based on an aggregate trade cost and an aggregate market value for the one or more transactions;
determine a materiality score indicative of the materiality of the break within the materiality context based on the net materiality difference and the contextualization value;
identify a plurality of breaks within the materiality context;
determine, for each of the plurality of breaks, a respective materiality score; and
display, on a display, the plurality of breaks in an order that corresponds to the respective materiality scores of each of the plurality of breaks.

19. The system of claim 18, wherein the processor is further configured to:
identify a plurality of breaks within the materiality context;
determine, for each of the plurality of breaks, a respective materiality score; and
display, on a display, the plurality of breaks in an order that corresponds to the respective materiality scores of each of the plurality of breaks.

20. A non-transitory computer readable medium storing instructions that, when executed by a processor, programs the processor to:
identify a break associated with an asset based on detection of an exception quantity across one or more transactions of the asset, the exception quantity corresponding to an amount of difference in a net quantity value based on one or more positions of the one or more transactions of the asset;
determine a market price and a trade price of the asset associated with the one or more transactions that make up the one or more positions for the asset;
determine a contextualization value based on a materiality context associated with the one or more transactions for scoring the materiality of the break;
determine, for each of the one or more transactions, a trade cost based on the trade price and position of the respective transaction;
determine, for each of the one or more transactions, a market value based on the market price and position of the respective transaction;
determine a net materiality difference based on an aggregate trade cost and an aggregate market value for the one or more transactions;
determine a materiality score indicative of the materiality of the break within the materiality context based on the net materiality difference and the contextualization value;
identify a plurality of breaks within the materiality context;
determining, for each of the plurality of breaks, a respective materiality score; and
displaying, on a display, the plurality of breaks in an order that corresponds to the respective materiality scores of each of the plurality of breaks.
